(19) United States
(12) Patent Application Publication
(10) Pub. No.: US 2008/0141968 A1
(43) Pub. Date: Jun. 19, 2008

(54) INTAKE MANIFOLD ASSEMBLY

(75) Inventors: JIAN JUN ZHANG, Rochester, NY (US); Ko-Jen Wu, Troy, MI (US); William A. Berry, Davison, MI (US); James C. Elmslie, Oxford, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM Global Technology Operations, Inc., Detroit, MI (US)

(21) Appl. No.: 11/612,013

(22) Filed: Dec. 18, 2006

(51) Int. Cl. F02M 35/104

(52) U.S. Cl. 123/184.46; 123/184.47

(57) ABSTRACT

An intake manifold assembly is provided having a plenum and an intake runner in communication with the plenum. The intake runner has an outlet end. A selectively closeable throttle plate is disposed within the intake runner and is operable to selectively limit the flow of intake air through the intake runner. The throttle plate is selectively and variably movable between a fully opened position and a fully closed position. An orifice, defined by one of the intake runner and the throttle plate, has an opening area of approximately fifteen percent or less of a cross sectional area of the outlet end. An internal combustion engine incorporating the intake manifold assembly is also disclosed.

### TECHNICAL FIELD

The present invention relates to an intake manifold assembly for an internal combustion engine.

### BACKGROUND OF THE INVENTION

An internal combustion engine typically incorporates an intake manifold assembly to provide intake air to an intake port for subsequent introduction to a combustion chamber where it is combusted with an amount of fuel. The intake manifold assembly typically includes a plenum and at least one intake runner in communication with the plenum and intake port. Conventional intake manifold assemblies allow unrestricted communication between the intake runner and intake port, thereby allowing an amount of products of combustion, sometimes referred to as residual gas, to traverse the intake port and enter the intake runner and plenum during low speed and load modes of engine operation, such as idle or near idle. This condition is most prevalent with internal combustion engines having a large amount of valve overlap, i.e. the period between the opening of an intake valve and the closing of an exhaust valve. The presence of products of combustion within the intake manifold assembly may dilute the intake air and produce poor idle quality.

### SUMMARY OF THE INVENTION

An intake manifold assembly is provided for an internal combustion engine. The intake manifold assembly includes a plenum and an intake runner in communication with the plenum. The intake runner has an interior wall and an outlet end. A selectively closeable throttle plate is disposed within the intake runner and is operable to selectively limit the flow of intake air through the outlet end. The throttle plate is selectively and variably movable between a fully opened position and a fully closed position. An orifice is defined by tile throttle plate and has an opening area of approximately fifteen percent or less of a cross sectional area of the outlet end. The intake runner has an inlet end, substantially adjacent to the plenum volume, and the outlet end is substantially adjacent to the internal combustion engine. The throttle plate is preferably disposed substantially adjacent to the outlet end.

In an alternate embodiment, an intake manifold for an internal combustion engine is provided having a plenum and an intake runner in communication with the plenum. The intake runner has an interior wall and an outlet end. A selectively closeable throttle plate is disposed within the intake runner and is operable to selectively limit the flow of intake air through the outlet end. The throttle plate is selectively and variably movable between a fully opened position and a fully closed position. An orifice is defined by the intake runner and has an opening area of approximately fifteen percent or less of a cross sectional area of the outlet end. The orifice is positioned downstream of the throttle plate. The intake runner has an inlet end, substantially adjacent to the plenum volume, and the outlet end is substantially adjacent to the internal combustion engine. The throttle plate is preferably disposed substantially adjacent to the outlet end. An internal combustion engine incorporating the intake manifold assemblies of the present invention is also disclosed.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of a portion of an internal combustion engine incorporating an intake manifold assembly of the present invention;

FIG. 2 is a perspective view of the intake manifold assembly of the present invention further illustrating aspects of the present invention;

FIG. 3 is a perspective view of an intake runner of the intake manifold assembly, shown in FIG. 2, viewed from an outlet end of the intake runner; and

FIG. 4 is a schematic illustration of a portion of an internal combustion engine, similar to that shown in FIG. 1, illustrating an alternate embodiment of the intake manifold assembly of the present invention.

### DESCRIPTION OF THE PREFERRED EMBODIMENTS

Referring to the drawings wherein like reference numbers correspond to like or similar components throughout the several figures, a portion of an internal combustion engine is schematically depicted and generally indicated as 10. The internal combustion engine 10 includes a cylinder block 12 defining a cylinder bore 14 having a piston 16 reciprocally movable therein. A cylinder head 18 is mounted to the cylinder block 12 and is operable to close one end of the cylinder bore 14. The cylinder bore 14, cylinder head 18, and piston 16 cooperate to form a variable volume combustion chamber 20 within which fuel and intake air, indicated by arrow 21, are combusted during operation of the internal combustion engine 10.

The cylinder head 18 contains a selectively openable poppet valve or intake valve 22. The intake valve 22 is operable to selectively open an intake port 24, defined by the cylinder head 18, to the combustion chamber 20. Therefore, the intake valve 22 is operable to selectively introduce intake air 21 or a mixture of intake air 21 and fuel into the combustion chamber 20 for subsequent combustion. An intake manifold assembly 26 is mounted with respect to the cylinder head 18 and selectively and variably provides intake air 21 to the intake port 24. The intake manifold assembly 26 includes a plenum 28 and an intake runner 30. The intake runner includes an inlet end 32, in communication with the plenum 28, and an outlet end 34, in communication with the intake port 24. The intake runner 30 has an internal wall 36 defining a passageway to communicate intake air 21 between the plenum 28 and the intake port 24. A throttle body 38 is mounted with respect to the plenum 28 and includes a valve 39 operable to selectively and variably admit intake air 21 into the plenum 28.

A throttle valve 42 is mounted within the intake runner 30 and is substantially adjacent to the outlet end 34. The throttle valve 42 includes a throttle plate 44 mounted to a shaft 46, which is rotatable with respect to the intake runner 30. As such, the throttle plate 44 is selectively movable between a fully opened position and a fully closed position thereby selectively and variably limiting the flow of intake air 21 from the intake runner 30 to the intake port 24. The throttle plate 44 drawn in solid is shown in the fully closed position, while the throttle plate 44 drawn in dashed lines is shown in the fully opened position. An actuator assembly 48 is operable to control the movement of the throttle valve 42. The actuator assembly 48 receives control signals from a controller 50. The controller 50 may included a pre-programmable, microprocessor based, digital computer of a type generally known in the art.

A fuel injector 52 is at least partially housed within the intake runner 30 and is positioned downstream of the throttle valve 42. The fuel injector 52 is preferably positioned to inject a measured amount of fuel directly into the intake port 24 for subsequent introduction to the combustion chamber 20. Therefore, the internal combustion engine 10 may be characterized as having port fuel injection. Those skilled in the art will recognize that the present invention may be used with internal combustion engines having alternate fuel injection strategies, such as direct injection. The fuel injector 52 receives control signals from the controller 50.

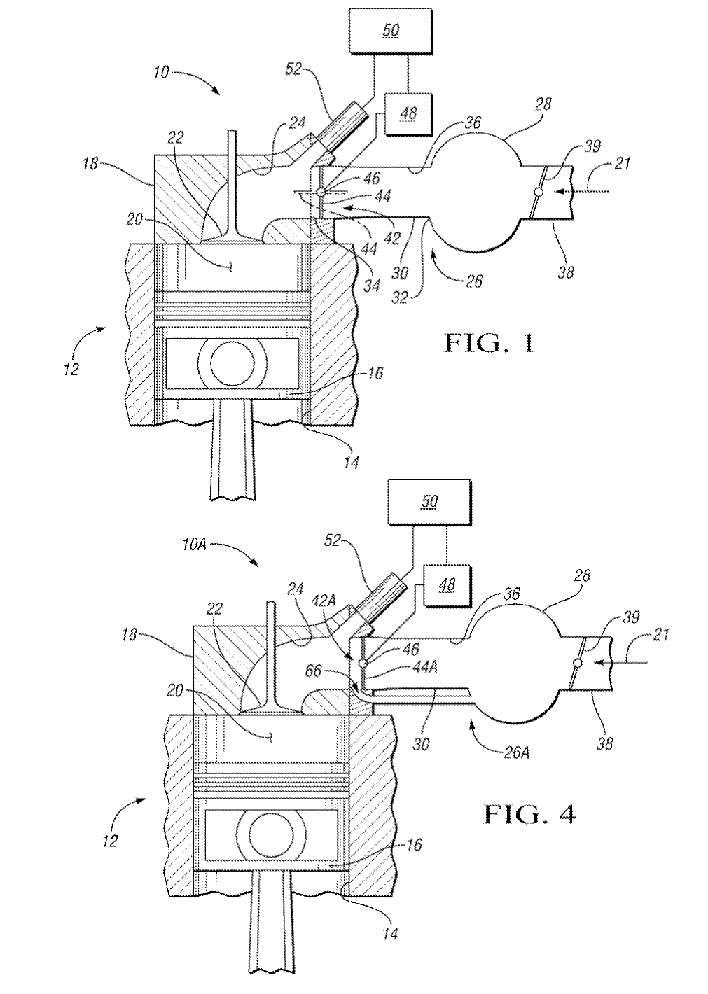

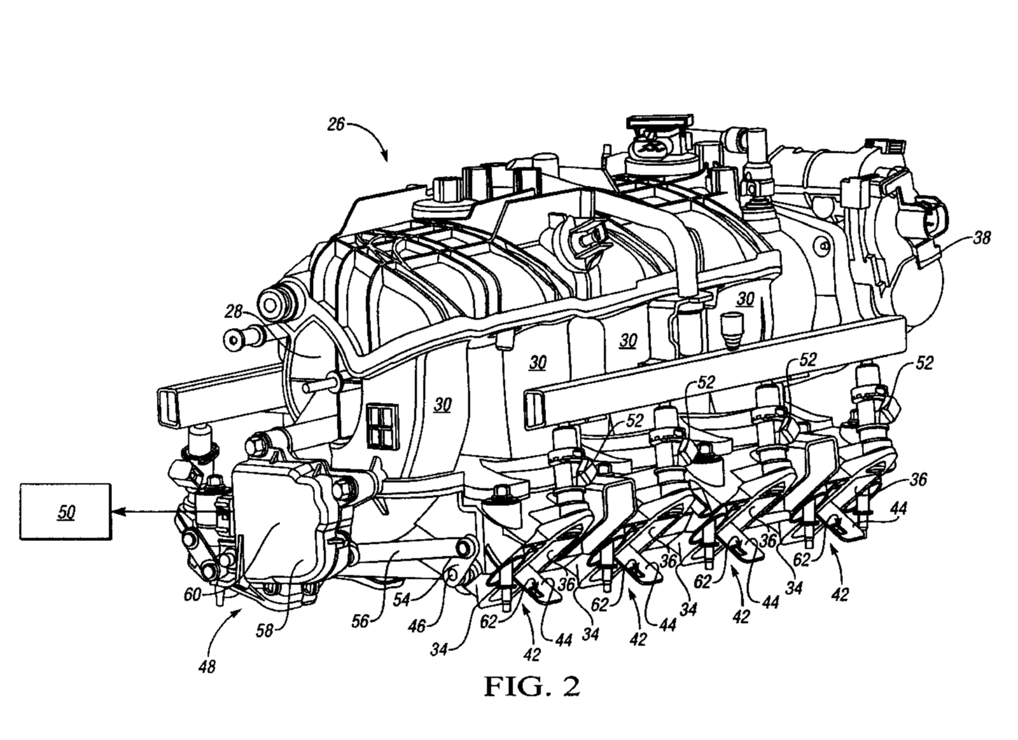

Referring now to FIG. 2, and with continued reference to FIG. 1, there is shown a perspective view of the intake manifold assembly 26 of the present invention. The intake manifold assembly 26, as shown in FIG. 2, is configured for use with an eight cylinder, V-type internal combustion engine. A bell crank 54 is mounted with respect to the shaft 46 for unitary rotation therewith. A link 56 interconnects the bell crank 54 and the actuator assembly 48. The actuator assembly 48 includes a motor 58, operable to effect movement of the link 56 and therefore the shaft 46, and a feedback position sensor 60, operable to provide a position signal to the controller 50 indicating the rotational position of the shaft 46.

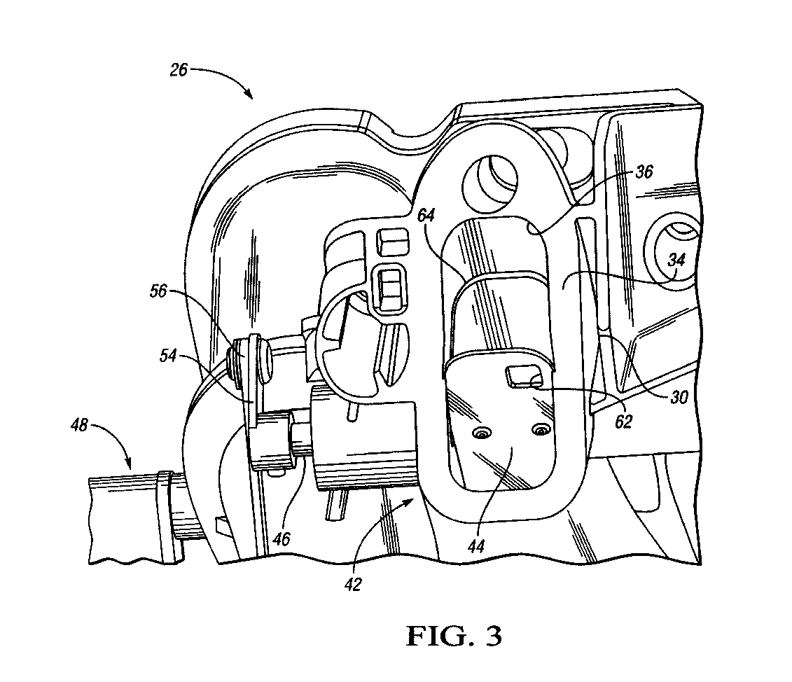

The throttle plate 44 defines an orifice 62, shown in FIG. 3, which in the preferred embodiment has an opening area less than or equal to approximately fifteen percent of the cross sectional area of the intake runner 30 at the point where the throttle valve 42 is positioned. Preferably, the orifice is positioned within the throttle plate 44 to optimize mixture motion, i.e. tumble and/or swirl, within the combustion chamber 20 of the internal combustion engine 10 when the throttle plate 44 is in the closed position. Those skilled in the art will recognize the many different intake runner and intake port geometries are possible with differing internal combustion engine architectures; therefore, careful analysis must be made to determine the optimal placement of the orifice 62.

Referring to FIG. 3, there is shown a perspective view of a portion of the intake manifold assembly 26 of FIG. 2. A rearward facing lip 64 is formed on the interior wall 36 of the intake runner 30. The lip 64 is sufficiently configured to sealingly engage the throttle plate 44 when the throttle plate 44 is in the fully closed position. In the preferred embodiment, the interior wall 36 of the intake runner 30 will gradually diverge upstream (i.e. moving from the inlet end 32 toward the throttle valve 42) of the throttle valve 42 and gradually converge downstream (i.e. moving from the throttle valve 42 toward the outlet end 34) of the throttle valve 42. In doing so, the effects on flow restriction of intake air 21 induced by the throttle plate 44 and shaft 46 when in the fully opened position are reduced or obviated.

The operation of the internal combustion engine 10 can best be discussed with reference to FIGS. 1 through 3. When the internal combustion engine 10 is operating in a low speed, low load mode of operation, such as idle or near idle engine operation, the throttle plate 44 of the throttle valve 42 is preferably placed in the fully closed position by the actuator assembly 48. In doing so, the flow of intake air 21 into the intake port 24 from the intake runner 30 is substantially restricted with the exception of the intake air 21 flowing through the orifice 62, shown in FIGS. 2 and 3. As the intake air 21 flows through the orifice 62, the placement of the orifice will increase mixture motion within the combustion chamber 20 thereby enhancing combustion of the fuel therein. With the throttle plate 44 in the fully closed position, the power of the internal combustion engine 10 may be varied, to a point, by selectively opening the valve 39. Additionally, the throttle plate 44 is effective in blocking the backflow of products of combustion or residual gas into the intake manifold assembly 26 during periods of valve overlap, thereby substantially reducing the rough engine operation that may result from dilution of the intake air 21 during idle engine operation. As the speed and load requirement of the internal combustion engine 10 increases, the actuator assembly 48 will gradually open the throttle plate 44 to allow a greater flow of intake air 21 from the intake runner 30 to the intake port 24. At a predetermined high speed, high load mode of operating the internal combustion engine 10, the throttle plate 44 is placed in the fully opened position to allow the potential for the maximum flow of intake air 21 from the intake runner 30 to the intake port 24.

Referring to FIG. 4, there is shown a schematic illustration of an alternate embodiment of the internal combustion engine 10 of FIG. 11 generally indicated at 10A. The internal combustion engine 10A has generally the same architecture as the internal combustion engine 10; however, an alternate embodiment of the intake manifold assembly 26 of FIG. 1 is generally indicated at 26A. The intake manifold assembly 26A includes a throttle valve 42A mounted within the intake runner 30 and substantially adjacent to the outlet end 34. The throttle valve 42A includes a throttle plate 44A mounted to the shaft 46, which is rotatable with respect to the intake runner 30. As such, the throttle plate 44A is selectively movable between the fully opened position and the fully closed position thereby selectively and variably restricting the flow of intake air 21 from the intake runner 30 to the intake port 24. The throttle plate 44A is shown in FIG. 4 in the fully closed position. The throttle plate 44A is similar to the throttle plate 44 of FIGS. 1 through 3 with the exception that the orifice 62 is absent in the throttle plate 44A. An orifice 66 is defined by the intake runner 30 and is in communication with the plenum 28. The orifice 66 is positioned downstream from the throttle valve 42A and is preferably positioned to optimize mixture motion within combustion chamber 20 of the internal combustion engine 10A. The orifice 66, in the preferred embodiment, has an opening area less than or equal to approximately fifteen percent of the cross sectional area of the intake runner 30 at the point where the throttle valve 42A is positioned. The operation of the internal combustion engine 10A is substantially similar to that of the internal combustion engine 10 described hereinabove with reference to FIGS. 1 through 3; however, with the throttle plate 44A in the fully closed position, the intake air 21 is provided to the intake port 24 through the orifice 66.

Referring to FIGS. 1 through 4, the intake manifold assemblies 26 and 26A are effective in reducing the backflow of products of combustion at idle or near idle operating conditions, while enhancing mixture motion within the combustion chamber 20. Additionally, the intake manifold assemblies 26 and 26A provide the ability to alter the flow direction of the intake air 21 within the combustion chamber to produce enhanced flame kernel growth and subsequent flame front development. By providing a well mixed intake air 21 and fuel mixture within the combustion chamber 20 at the time of ignition, a faster combustion burn rate, reduced coefficient of variation of indicated mean effective pressure, and improved fuel economy may be achieved.

While the best modes for carrying out the invention have been described in detail, those familiar with the art to which this invention relates will recognize various alternative designs and embodiments for practicing the invention within the scope of the appended claims.

1. An intake manifold assembly for an internal combustion engine comprising:
a plenum;
at least one intake runner in communication with said plenum;
wherein said at least one intake runner has an outlet end;
a selectively closeable throttle plate disposed within said outlet end of said at least one intake runner and operable to selectively limit the flow of intake air through said outlet end;
wherein said throttle plate is selectively and variably movable between a fully opened position and a fully closed position; and
an orifice defined by said throttle plate and having an opening area of approximately fifteen percent or less of a cross sectional area of said outlet end where said throttle plate is positioned.

2. The intake manifold assembly of claim 1, wherein said at least one intake runner has an inlet end substantially adjacent to said plenum volume and wherein said outlet end is substantially adjacent to the internal combustion engine, said throttle plate being disposed substantially adjacent to said outlet end.

3. The intake manifold of claim 1, wherein said at least one intake runner has an interior wall, said interior wall gradually diverges upstream of said throttle plate and wherein said interior wall converges downstream of said throttle plate to limit flow restriction within said at least one intake runner caused by said throttle plate when in said fully opened position.

4. The intake manifold of claim 1, wherein said at least one intake runner has an interior wall and wherein a lip portion is formed on said interior wall and is operable to sealingly engage said throttle plate when said throttle plate is in said fully closed position.

5. The intake manifold of claim 1, wherein said orifice is positioned within said throttle plate to optimize mixture motion within a cylinder of the internal combustion engine.

6. The intake manifold of claim 1, further comprising an actuator assembly operable to selectively and variably move said throttle plate between said fully opened position and said fully closed position.

7. The intake manifold assembly of claim 6, further comprising a feedback position sensor operable to communicate the position of said throttle plate to said actuator.

8. The intake manifold assembly of claim 1, further comprising a throttle body mounted with respect to said plenum and operable to selectively and variably introduce intake air to said plenum.

9. An intake manifold for an internal combustion engine comprising:
a plenum;
at least one intake runner in communication with said plenum;
wherein said at least one intake runner has an outlet end;
a selectively closeable throttle plate disposed within said outlet end of said at least one intake runner and operable to selectively limit the flow of intake air through said outlet end;
wherein said throttle plate is selectively and variably movable between a fully opened position and a fully closed position;
an orifice defined by said at least one intake runner and having an opening area of approximately fifteen percent or less of a cross sectional area of said outlet end; and
wherein said orifice is positioned downstream of said throttle plate.

10. The intake manifold assembly of claim 9, wherein said orifice is in communication with said plenum.

11. The intake manifold assembly of claim 9, wherein said at least one intake runner has an inlet end substantially adjacent to said plenum volume and wherein said outlet end is substantially adjacent to the internal combustion engine, said throttle plate being disposed substantially adjacent to said outlet end.

12. The intake manifold of claim 9, wherein said at least one intake runner has an interior wall, wherein said interior wall gradually diverges upstream of said throttle plate and wherein said interior wall converges downstream of said throttle plate to limit flow restriction within said intake runner caused by said throttle plate when said throttle plate is in said fully opened position.

13. The intake manifold of claim 9, wherein said at least one intake runner has an interior wall, and wherein a lip portion is formed on said interior wall and is operable to sealingly engage said throttle plate when in said fully closed position.

14. The intake manifold of claim 9, wherein said orifice is positioned within said at least one intake runner to optimize mixture motion within a cylinder of the internal combustion engine.

15. The intake manifold assembly of claim 9, further comprising a throttle body mounted with respect to said plenum and operable to selectively and variably introduce intake air to said plenum.

16. An internal combustion engine comprising:
a cylinder head defining an intake port;
an intake manifold assembly mounted with respect to said cylinder head and in communication with said intake port, said intake manifold assembly comprising:
a plenum;
at least one intake runner in communication with said plenum;
wherein said at least one intake runner has an outlet end and an interior wall;
a selectively closeable throttle plate disposed within said outlet end of said at least one intake runner and operable to selectively limit the flow of intake air through said outlet end;
wherein said throttle plate is selectively and variably movable between a fully opened position and a fully closed position;
an orifice defined by one of said at least one intake runner and said throttle plate, said orifice having an opening area of approximately fifteen percent or less of a cross sectional area of said outlet end;
a lip portion formed on said interior wall and operable to sealingly engage said throttle plate when in said fully closed position; and
wherein said at least one intake runner has an inlet end substantially adjacent to said plenum volume and wherein said outlet end is substantially adjacent to the internal combustion engine, said throttle plate being disposed substantially adjacent to said outlet end.

17. The internal combustion engine of claim 16, wherein said orifice is defined by said at least one intake runner and wherein said orifice is positioned downstream of said throttle plate and in communication with said plenum.

18. The internal combustion engine of claim 16, further comprising a throttle body mounted with respect to said plenum and operable to selectively and variably introduce intake air to said plenum.

19. The internal combustion engine of claim 16, wherein said interior wall gradually diverges upstream of said throttle plate and wherein said interior wall converges downstream of said throttle plate to limit flow restriction within said at least one intake runner caused by said throttle plate when said throttle plate is in said fully opened position.

20. The internal combustion engine of claim 16, wherein said orifice is positioned within said at least one intake runner to optimize mixture motion within a cylinder of the internal combustion engine.
